(19) United States
(12) Patent Application Publication
(10) Pub. No.: US 2011/0073285 A1
(43) Pub. Date: Mar. 31, 2011

(54) Multi-Zone Heat Exchanger for Use in a Vehicle Cooling System

(75) Inventors: Ryan J. Benoit, Bowmanville (CA); Rick H. Rajaie, Auburn Hills, MI (US)

(73) Assignee: GM GLOBAL TECHNOLOGY OPERATIONS, INC., Detroit, MI (US)

(21) Appl. No.: 12/569,972

(22) Filed: Sep. 30, 2009

(51) Int. Cl. F28D 15/00; F16K 11/074

(52) U.S. Cl. 165/104.28; 137/627

(57) ABSTRACT

A multi-zone cooling system and method of operation employs a multi-zone heat exchanger that is used to cool fluids in multiple cooling loops in a vehicle. The multi-zone heat exchanger has a zone that can be used by one or the other of the cooling loops when needed during peak operating conditions for the component requiring peak cooling.

### BACKGROUND OF INVENTION

The present invention relates generally to fluid cooling systems employed with automotive vehicles.

A condenser, radiator, fan module (CRFM) for an automotive vehicle typically includes several separate heat exchangers for cooling fluids that flow through various vehicle subsystems. In more recent vehicles, such as hybrid vehicles, with an increase in the number of subsystems the number of cooling loops has increased, and thus the number of heat exchangers in the CRFM has also increased. Moreover, each of these heat exchangers is sized to meet the cooling requirements for its respective cooling loop under that particular loop's peak load conditions. These heat exchangers, then, take up more packaging space in the CRFM than is desired. Consequently, it is desirable to meet the peak cooling demands for each of the cooling loops while reducing the packaging space required for heat exchangers in the CRFM.

### SUMMARY OF INVENTION

An embodiment contemplates a multi-zone cooling system for use in a vehicle. The cooling system may comprise a multi-zone heat exchanger, a first cooling loop and a second cooling loop. The multi-zone heat exchanger may have a first zone, a second zone and a third zone, a first one-way check valve between the first zone and the second zone configured to only allow fluid flow from the first zone to the second zone and a second one-way check valve between the third zone and the second zone configured to only allow fluid flow from the third zone to the second zone, a zone one fluid inlet, a zone one fluid outlet, a zone three fluid inlet, a zone three fluid outlet, a first zone two fluid outlet and a second zone two fluid outlet. The first cooling loop may include a first three-way valve having a first inlet for receiving fluid flow from the zone one fluid outlet, a second inlet for receiving fluid flow from the first zone two fluid outlet and a valve outlet, with the first three-way valve being controllable to selectively block fluid flow from one or the other of the first inlet and the second inlet. The second cooling loop may include a second three-way valve having a third inlet for receiving fluid flow from the zone three fluid outlet, a fourth inlet for receiving fluid flow from the second zone two fluid outlet and a valve outlet, with the second three-way valve being controllable to selectively block fluid flow from one or the other of the third inlet and the fourth inlet.

An embodiment contemplates a multi-zone cooling system for use in a vehicle that may comprise a multi-zone heat exchanger having a first zone, a second zone and a third zone; a first cooling loop that provides a flow of a fluid through a first vehicle component to cool the first vehicle component, with the first cooling loop configured to direct fluid flow from the first cooling loop into the first zone; a second cooling loop that provides a flow of the fluid through a second vehicle component to cool the second vehicle component, with the second cooling loop configured to direct fluid flow from the second cooling loop into the third zone; a first valve that selectively allows for fluid flow from one or the other of the first zone and the second zone into the first cooling loop; a second valve that selectively allows for fluid flow from one or the other of the third zone and the second zone into the second cooling loop; and a controller engaging the first and second valves to control switching of the first and second valves.

An embodiment contemplates a method of operating a multi-zone cooling system in a vehicle including a first cooling loop for providing cooling for a first vehicle component and a second cooling loop for providing cooling for a second vehicle component, the method comprising the steps of: (a) directing fluid flow from the first cooling loop into a first zone of a multi-zone heat exchanger and back into the first cooling loop from the first zone during a first operating condition for the first vehicle component; (b) directing fluid flow from the second cooling loop into a third zone of the multi-zone heat exchanger and back into the second cooling loop from the third zone during a first operating condition for the second vehicle component; (c) directing fluid flow from the first cooling loop into the first zone of the multi-zone heat exchanger, from the first zone to a second zone of the multi-zone heat exchanger and back into the first cooling loop from the second zone during a first cooling loop peak operating condition where peak cooling for the first vehicle component is needed; (d) while performing step (c), directing fluid flow from the second cooling loop into the third zone of the multi-zone heat exchanger and back into the second cooling loop from the third zone during the first operating condition for the second vehicle component; (e) directing fluid flow form the second cooling loop into the third zone of the multi-zone heat exchanger, from the third zone to the second zone of the multi-zone heat exchanger and back into the second cooling loop from the second zone during a second cooling loop peak operating condition where peak cooling for the second vehicle component is needed; and (f) while performing step (e), directing fluid flow from the first cooling loop into the first zone of the multi-zone heat exchanger and back into the first cooling loop from the first zone during the first operating condition for the first vehicle component.

An advantage of an embodiment is that a reduced number of heat exchangers is employed in the CRFM of the vehicle while still providing adequate cooling for peak cooling loads of the various cooling loops. This reduced number of heat exchangers may reduce the cost and improve the packaging of the CRFM in the vehicle.

An advantage of an embodiment is that two separate coolant loops using the same coolant and seeing peak loads typically under distinct operating conditions will operate through different zones of a single heat exchanger, with a shared zone that provides the additional cooling capacity to account for the distinct peak load conditions of the two loops. In effect, additional reserve cooling capacity is available for either loop when a high cooling load condition arises for one of the two loops, allowing for variable cooling capacity for each of these two loops. In effect, this one multi-zone heat exchanger acts as essentially four heat exchangers, while minimizing the packaging space.

An advantage of an embodiment may be that the use of the multi-zone heat exchanger may allow for a reduction in vehicle drag, a reduction in engine fan coolant pump power consumption, and a reduced overall pressure drop in the fluids across the CRFM.

### BRIEF DESCRIPTION OF DRAWINGS

FIG. 1 is a schematic diagram of a portion of a vehicle.

FIG. 2 is a schematic diagram of portions of a multi-zone cooling system operating in a first mode.

FIG. 3 is a schematic diagram similar to FIG. 2, but shown operating in a second mode.

FIG. 4 is a schematic diagram similar to FIG. 2, but shown operating in a third mode.

### DETAILED DESCRIPTION

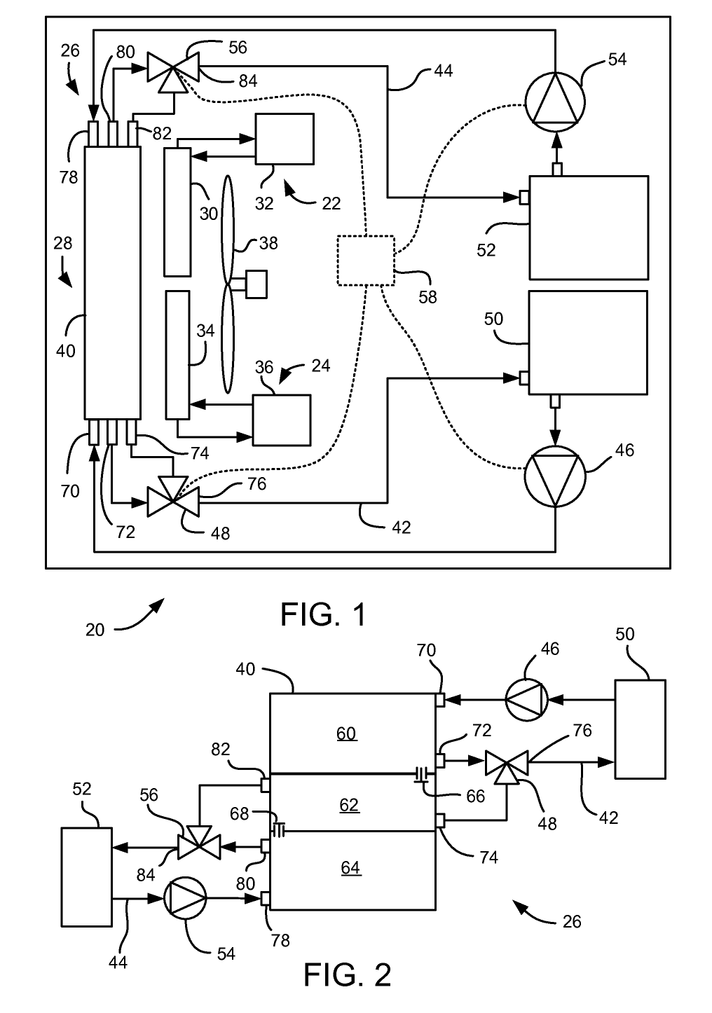

Referring to FIGS. 1 and 2, a portion of a vehicle 20 is schematically illustrated. The vehicle 20 may include several types of cooling systems, such as, for example, a transmission oil cooling system 22, a refrigerant system 24 for a heating ventilation and air conditioning (HVAC) system, and a multi-zone cooling system 26. Typically, these cooling systems will have heat exchangers mounted near a front opening of the vehicle in what is commonly called a condenser, radiator, fan module (CRFM) 28. The transmission oil cooling system 22 may include a heat exchanger 30 (oil cooler) mounted in the CRFM 28 for cooling oil in a transmission oil loop 32 that brings transmission oil from and sends it back to a transmission (not shown). The refrigerant system 24 may include a condenser 34 mounted in the CRFM 28 for removing heat from refrigerant flowing through a refrigerant loop 36. The CRFM 28 also includes a fan 38 that is employed to draw air through the heat exchangers in the CRFM 28.

The multi-zone cooling system 26 includes a multi-zone heat exchanger 40 that may be contained in the CRFM 28 and is connected to two different cooling loops, a first cooling loop 42 and a second cooling loop 44. The first cooling loop 42 may be, for example, an internal combustion engine coolant loop and may contain a conventional type of coolant mixture, such as water and ethylene glycol. This coolant loop 42 may direct the coolant through, for example, an internal combustion engine 50 and an HVAC heater core (not shown). This cooling loop may be employed to cool a different component or subsystem, if so desired, such as, for example, a battery pack or battery related electronics components. The term “component” as used herein when referring to items cooled by the cooling loop includes a subsystem or subsystems and just refers to one or more items being cooled by the fluid in that particular loop. The first cooling loop 42 may include an electronically controllable pump 46 for pumping the coolant through the loop 42, and an electronically controllable 3-way valve 48 for redirecting the coolant flow through the loop 42.

The second cooling loop 44 may be a powertrain electronics cooling loop containing the same coolant mixture as the first cooling loop 42. This coolant loop 44 may direct the coolant through, for example, powertrain electronics such as a traction power inverter module 52. The second cooling loop 44 may include an electronically controllable pump 54 for pumping the coolant through the loop 44, and an electronically controllable 3-way valve 56 for redirecting the coolant flow through the loop 44. The valves 48, 56 may be separate from, mounted on or mounted in the multi-zone heat exchanger 40.

An electronic controller 58 may be connected to and control the operation of the pumps 46, 54 and the valves 48, 56 (as indicated by dotted lines in FIG. 1). The controller may be separate from or part of another vehicle controller, such as a powertrain control module, and may be made up of any combination of hardware and software as is known to those skilled in the art.

The multi-zone heat exchanger 40 interacts with both the first and second cooling loops 42, 44. This heat exchanger 40 is a single heat exchanger that is divided up into three zones, a first zone 60, a second zone 62 and a third zone 64. The coolant in the heat exchanger 40 cannot flow from the first zone 60 into the second zone 62 except through a zone 1-2 one-way check valve 66, and cannot flow from the second zone 62 directly back into the first zone 60 (i.e., without flowing through the first cooling loop 42). The coolant in the heat exchanger 40 cannot flow from the third zone 64 into the second zone 62 except through a zone 3-2 one-way check valve 68, and cannot flow from the second zone 62 directly back into the third zone 64 (i.e., without flowing through the second cooling loop 44). In addition, the heat exchanger 40 does not allow for coolant flow directly between the first zone 60 and the third zone 64.

The multi-zone heat exchanger 40 also includes a zone one inlet 70 into the first zone 60 that receives fluid flow from the pump 46 in the first cooling loop 42, a zone one outlet 72 that directs fluid flow from the first zone 60 toward a first inlet of the 3-way valve 48 in the first cooling loop 42, and a first zone two outlet 74 that directs fluid flow from the second zone 62 toward a second inlet of the 3-way valve 48 in the first cooling loop 42. An outlet 76 from the 3-way valve 48 directs the fluid into the rest of the first cooling loop 42 (such as the internal combustion engine 50). Alternatively, the pump 46 may be located between the 3-way valve 48 and the internal combustion engine 50 rather than between the engine 50 and the zone one inlet 70, if so desired.

A zone three inlet 78 into the third zone 64 receives fluid into the third zone 64 from the pump 54 in the second cooling loop 44, a zone three outlet 80 directs fluid flow from the third zone 64 toward a first inlet of the 3-way valve 56 in the second cooling loop 44, and a second zone two outlet 82 directs fluid flow from the second zone 62 toward a second inlet of the 3-way valve 56. An outlet 84 from the 3-way valve 56 directs the fluid into the rest of the second cooling loop 44 (such as the traction power inverter module 52). Alternatively, the pump 54 may be located between the 3-way valve 56 and the traction power inverter module 52 rather than between the inverter module 52 and the zone three inlet 78, if so desired.

Thus, for fluid flow, the first zone 60 is always connected to the first cooling loop 42, the third zone 64 is always connected to the second cooling loop 44 and the second zone 62 may be connected to one of the first or second loops 42, 44 or to neither of the cooling loops. This allows for three distinct modes of coolant cooling for the multi-zone heat exchanger 40 as it interacts with the first and second cooling loops 42, 44.

The arrow heads on the fluid lines in FIGS. 1 and 2 show the flow of fluids for a first operating mode. In this mode, the first and second cooling loops 42, 44 are both operating under normal cooling loads. The pumps 46, 54 are activated, the first 3-way valve 48 is set to direct fluid flow from the zone one outlet 72 through to the 3-way valve outlet 76 and block flow from the first zone two outlet 74, and the second 3-way valve 56 is set to direct fluid flow from the zone three outlet 80 through to the 3-way valve outlet 84 and block flow from the second zone two outlet 82. Accordingly, the coolant in the first cooling loop 42 only flows through the first zone 60 and the coolant in the second cooling loop 44 only flows through the third zone 64. Fluid is not flowing through the second zone 62 and so this zone does not contribute to the cooling of the coolant. While the cooling capacity of the first zone 60 is less than the peak needed for cooling in the first cooling loop 42 under peak load conditions, the heat exchanger capacity in first zone 60 is sized to be sufficient to meet the cooling demands under normal load conditions for the first cooling loop 42. The same is true for the third zone 64 and the second cooling loop 44.

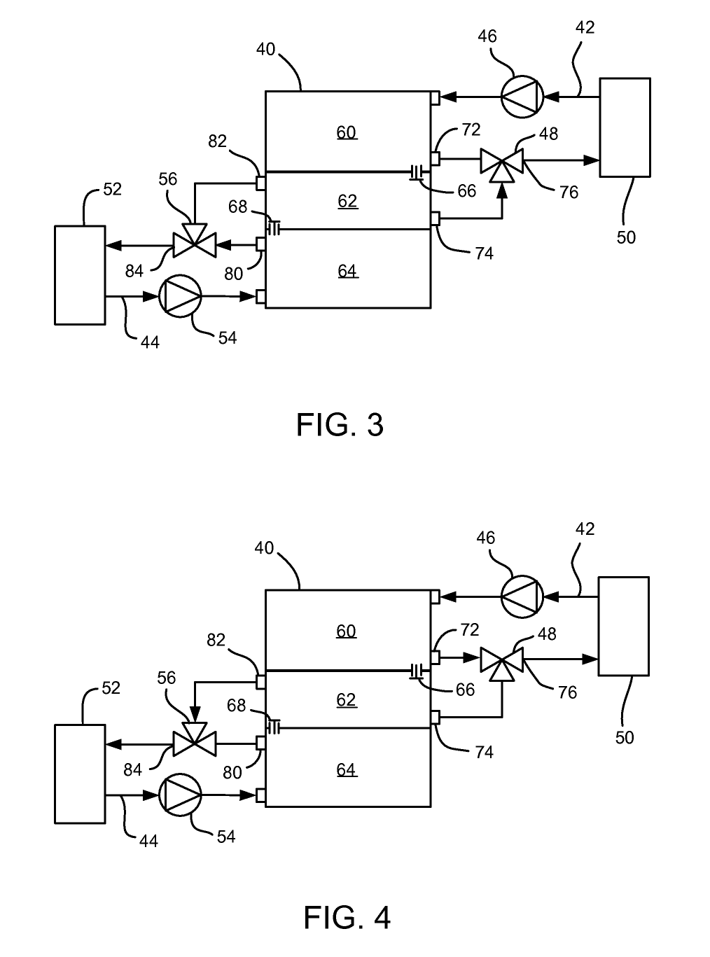

FIG. 3 illustrates a second operating mode where the first cooling loop 42 is operating under peak cooling load conditions and the second cooling loop is operating under normal cooling load conditions. For example, the engine 50 may require peak cooling while the traction power inverter module 52 only requires normal cooling. In this operating mode, the pumps 46, 54 are activated, the first 3-way valve 48 is switched to direct fluid flow from the first zone two outlet 74 through to the 3-way valve outlet 76 and block flow from the zone one outlet 72, and the second 3-way valve 56 is set to direct fluid flow from the zone three outlet 80 through to the 3-way valve outlet 84 and block flow from the second zone two outlet 82. Accordingly, the coolant in the second cooling loop 44 only flows through the third zone 64 of the multi-zone heat exchanger 40. However, the coolant in the first cooling loop 42 now flows through the first zone 60, through the zone 1-2 check valve 66 and through the second zone 62. This flow through two zones of the heat exchanger 40 significantly increases the cooling capacity, thus meeting the peak cooling requirements for the first cooling loop 42. The zone 2-3 check valve 68 will block the flow of the coolant from the second zone 62 into the third zone 64. Also, if so desired, the pump 46 may be variable capacity and be adjusted to further improve the cooling in the first cooling loop 42 under peak cooling load conditions.

FIG. 4 illustrates a third operating mode where the first cooling loop 42 is operating under normal cooling load conditions and the second cooling loop is operating under peak cooling load conditions. For example, the engine 50 may only require normal cooling while the traction power inverter module 52 requires peak cooling. In this operating mode, the pumps 46, 54 are activated, the first 3-way valve 48 is set to direct fluid flow from the zone one outlet 72 through to the 3-way valve outlet 76 and block flow from the first zone two outlet 74, and the second 3-way valve 56 is set to direct fluid flow from the second zone two outlet 82 through to the 3-way valve outlet 84 and block flow from the zone three outlet 80. Accordingly, the coolant in the first cooling loop 42 only flows through the first zone 60 of the multi-zone heat exchanger 40. However, the coolant in the second cooling loop 44 now flows through the third zone 64, through the zone 3-2 check valve 68 and through the second zone 62. This flow through two zones of the heat exchanger 40 significantly increases the cooling capacity, thus meeting the peak cooling requirements for the second cooling loop 44. The zone 1-2 check valve 66 will block the flow of the coolant from the second zone 62 into the first zone 60. Also, if so desired, the pump 54 may be variable capacity and be adjusted to further improve the cooling in the second cooling loop 44 under peak cooling load conditions.

For operation of this multi-zone cooling system 26 in the vehicle 20, the first and second cooling loops will have the same coolant mixture and the peak load conditions of these loops will have little to no overlap (i.e., when one loop demands peak cooling capacity the other can be managed with a much more reasonable cooling capacity). In addition, while this embodiment has been discussed with two cooling loops interacting with the multi-zone heat exchanger 40, it is contemplated that another embodiment could have, for example, a third cooling loop and the addition of another zone, check valve, pump, 3-way valve and corresponding inlets and outlets from the heat exchanger 40.

While certain embodiments of the present invention have been described in detail, those familiar with the art to which this invention relates will recognize various alternative designs and embodiments for practicing the invention as defined by the following claims.

1. A multi-zone cooling system for use in a vehicle comprising:
a multi-zone heat exchanger having a first zone, a second zone and a third zone, a first valve between the first zone and the second zone configured to selectively allow flow of a fluid from the first zone to the second zone and a second valve between the third zone and the second zone configured to selectively allow flow of the fluid from the third zone to the second zone, a zone one fluid inlet, a zone one fluid outlet, a zone three fluid inlet, a zone three fluid outlet, a first zone two fluid outlet and a second zone two fluid outlet;
a first cooling loop including a first valve assembly having a first inlet for receiving fluid flow from the zone one fluid outlet, a second inlet for receiving fluid flow from the first zone two fluid outlet and a valve outlet, the first valve assembly controllable to selectively block fluid flow from one or the other of the first inlet and the second inlet; and
a second cooling loop including a second valve assembly having a third inlet for receiving fluid flow from the zone three fluid outlet, a fourth inlet for receiving fluid flow from the second zone two fluid outlet and a valve outlet, the second three way valve assembly controllable to selectively block fluid flow from one or the other of the third inlet and the fourth inlet.

2. The multi-zone cooling system of claim 1 wherein the first cooling loop includes a first pump controllable to selectively pump the fluid through the first cooling loop.

3. The multi-zone cooling system of claim 2 wherein the second cooling loop includes a second pump controllable to selectively pump the fluid through the second cooling loop.

4. The multi-zone cooling system of claim 1 wherein the first loop includes an internal combustion engine through which fluid flow is directed.

5. The multi-zone cooling system of claim 1 wherein the second loop includes a traction power inverter module through which fluid flow is directed.

6. The multi-zone cooling system of claim 1 wherein the fluid in the first loop is a liquid coolant and the fluid in the second loop is a liquid coolant that is the same composition as the liquid coolant in the first loop.

7. The multi-zone cooling system of claim 1 including a controller that is configured to controllably switch the first and second three way valves valve assemblies.

8. A multi-zone cooling system for use in a vehicle comprising:
a multi-zone heat exchanger having a first zone, a second zone and a third zone;
a first cooling loop configured to provide a flow of a fluid through a first vehicle component for cooling the first vehicle component, the first cooling loop configured to direct fluid flow from the first cooling loop into the first zone;
a second cooling loop configured to provide a flow of the fluid through a second vehicle component for cooling the second vehicle component, the second cooling loop configured to direct fluid flow from the second cooling loop into the third zone;
at least a first valve configured to selectively allow for fluid flow from one or the other of the first zone and the second zone into the first cooling loop;
at least a second valve configured to selectively allow for fluid flow from one or the other of the third zone and the second zone into the second cooling loop; and
a controller controllably engaging the first and second valves to control switching of the first and second valves.

9. The multi-zone cooling system of claim 8 including a third valve that blocks fluid flow from the second zone into the first zone.

10. The multi-zone cooling system of claim 9 including a fourth valve that blocks the fluid flow from the second zone into the third zone.

11. The multi-zone cooling system of claim 8 wherein the first cooling loop includes a first pump controllable to selectively pump the fluid through the first cooling loop.

12. The multi-zone cooling system of claim 11 wherein the second cooling loop includes a second pump controllable to selectively pump the fluid through the second cooling loop.

13. The multi-zone cooling system of claim 8 wherein the fluid in the first loop is a liquid coolant and the fluid in the second loop is a liquid coolant that is the same composition as the liquid coolant in the first loop.

14. A method of operating a multi-zone cooling system in a vehicle including a first cooling loop for providing cooling for a first vehicle component and a second cooling loop for providing cooling for a second vehicle component, the method comprising the steps of:
(a) directing fluid flow from the first cooling loop into a first zone of a multi-zone heat exchanger and back into the first cooling loop from the first zone during a first operating condition for the first vehicle component;
(b) directing fluid flow from the second cooling loop into a third zone of the multi-zone heat exchanger and back into the second cooling loop from the third zone during a first operating condition for the second vehicle component;
(c) directing fluid flow from the first cooling loop into the first zone of the multi-zone heat exchanger, from the first zone to a second zone of the multi-zone heat exchanger and back into the first cooling loop from the second zone during a first cooling loop peak operating condition where peak cooling for the first vehicle component is needed;
(d) while performing step (c), directing fluid flow from the second cooling loop into the third zone of the multi-zone heat exchanger and back into the second cooling loop from the third zone during the first operating condition for the second vehicle component;
(e) directing fluid flow form the second cooling loop into the third zone of the multi-zone heat exchanger, from the third zone to the second zone of the multi-zone heat exchanger and back into the second cooling loop from the second zone during a second cooling loop peak operating condition where peak cooling for the second vehicle component is needed; and
(f) while performing step (e), directing fluid flow from the first cooling loop into the first zone of the multi-zone heat exchanger and back into the first cooling loop from the first zone during the first operating condition for the first vehicle component.

15. The method of claim 14 wherein step (c) further comprises increasing a speed of a first pump in the first cooling loop to increase the fluid flow during the first cooling loop peak operating condition.

16. The method of claim 15 wherein step (e) further comprises increasing a speed of a second pump in the second cooling loop to increase the fluid flow during the second cooling loop peak operating condition.

17. The method of claim 14 including providing a first one-way check valve between the first zone and the second zone thereby blocking fluid flow from the second zone into the first zone.

18. The method of claim 14 including providing a second one-way check valve between the third zone and the second zone thereby blocking fluid flow from the second zone into the first zone.

19. The multi-zone cooling system of claim 1 wherein the first valve assembly is a first three-way valve and the second valve assembly is a second three-way valve.

20. The multi-zone cooling system of claim 1 wherein the first valve is a one-way check valve and the second valve is a one-way check valve.
